(19) United States
(12) Patent Application Publication
(10) Pub. No.: US 2022/0358704 A1
(43) Pub. Date: Nov. 10, 2022

(54) ANIMATION PRODUCTION SYSTEM

(71) Applicants: XVI Inc., Chuo-ku (JP); Avex Technologies Inc., Minato-ku (JP)

(72) Inventors: Yoshihito KONDOH, Chuo-ku (JP); Masato MUROHASHI, Tokyo (JP)

(21) Appl. No.: 16/977,081

(22) PCT Filed: Sep. 24, 2019
(86) PCT No.: PCT/JP2019/037424

§ 371 Date: Aug. 31, 2020

(51) Int. Cl. G06T 13/40

(52) U.S. Cl. CPC G06T 13/40

(57) ABSTRACT

[Technical Problem] To enable to shoot animations in a virtual space. [Solution to Problem] An animation production method wherein a computer executes: a step of placing a character in a virtual space; a step of placing a virtual camera for shooting the character; a step of controlling the action of the character; and a step of generating a movie in which the character is virtually captured by the camera, wherein: a first frame rate in relation to the action in the step of controlling the action of the character and the second frame rate in relation to the action of the character output to the movie in the step of generating the movie are different.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention of the present invention for solving the above-described problem is an animation production method wherein a computer executes: a step of placing a character in a virtual space; a step of placing a virtual camera for shooting the character; a step of controlling the action of the character; and a step of generating a movie in which the character is virtually captured by the camera, wherein: a first frame rate in relation to the action in the step of controlling the action of the character and the second frame rate in relation to the action of the character output to the movie in the step of generating the movie are different.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating a functional configuration of an image producing device 310 according to the present embodiment;

FIG. 8 is a diagram illustrating a state in which each character 4 is duplexed.

### DESCRIPTION OF EMBODIMENTS

The contents of embodiments of the present invention will be described with reference. The present invention includes, for example, the following configurations.

### [Item 1]

An animation production method wherein

a computer executes:

a step of placing a character in a virtual space;

a step of placing a virtual camera for shooting the character;

a step of controlling the action of the character; and

a step of generating a movie in which the character is virtually captured by the camera,

wherein a first frame rate in relation to the action in the step of controlling the action of the character and the second frame rate in relation to the action of the character output to the movie in the step of generating the movie are different.

### [Item 2]

The animation production method according to claim 1, wherein

in the step of placing the character, two duplexed characters are placed,

in the step of controlling, displaying the action of one of the two characters at the first frame rate,

in the step of generating the movie, the action of the other of the two characters is output at the second frame rate.

### [Item 3]

An animation production method according to claim 1 or 2, wherein

the second frame rate is lower than the first frame rate.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

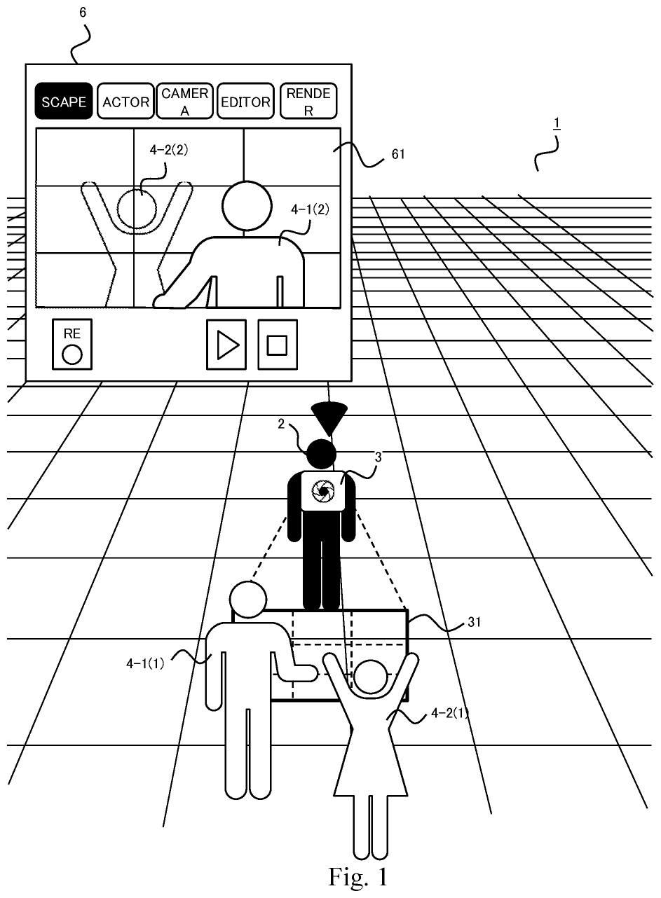

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3 are disposed in the virtual space 1, and a character 4 is shot using the camera 3. In the virtual space 1, a photographer 2 (a photographer character) is disposed, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 2 can be virtually operated as the photographer 2, natural camera work can be realized and the representation of the movie to be shot can be enriched.

### <General Configuration>

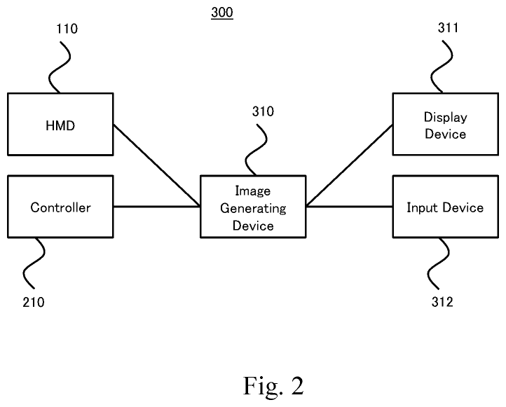

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. The image generating device 310 may include a display device 311, such as a display, and an input device 312, such as a keyboard, mouse, or touch panel. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### <HMD110>

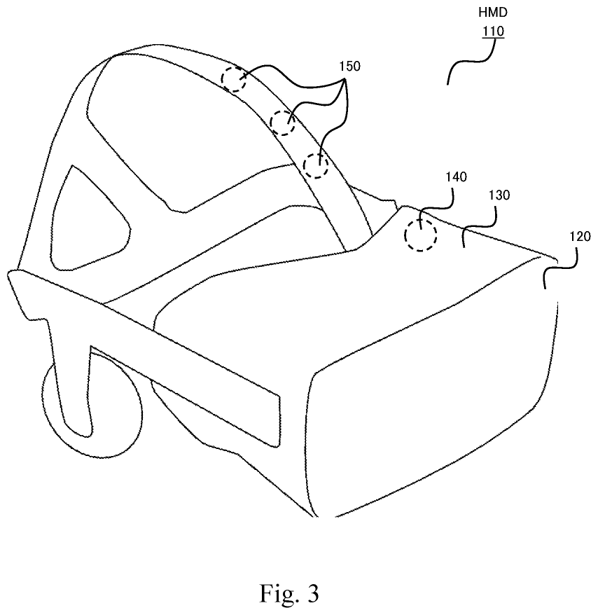

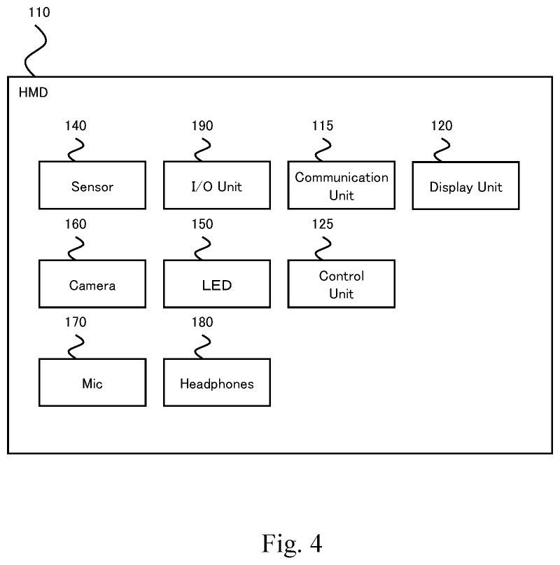

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### <Controller 210>

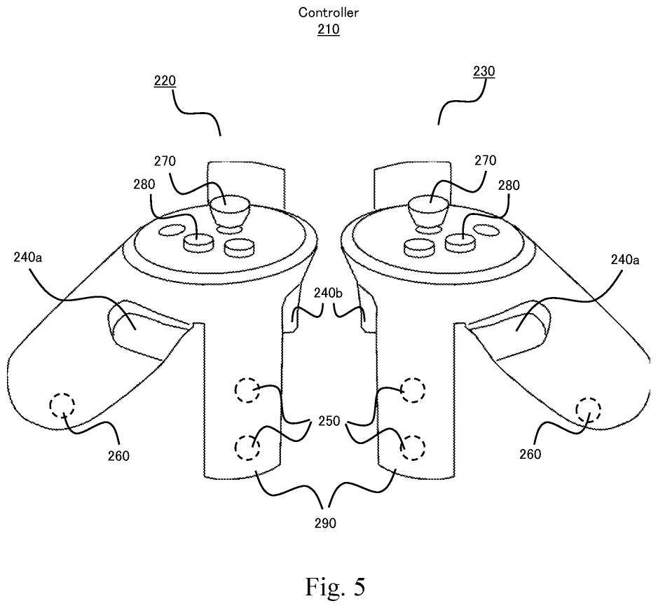

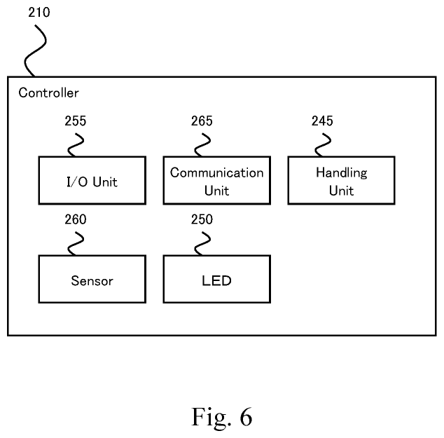

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### <Image Generator 310>

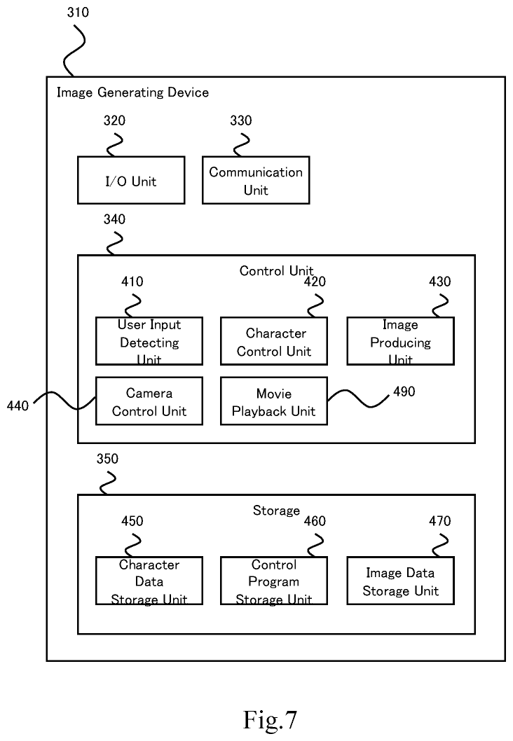

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110, the controller 210, and/or the input device 311 regarding the movement of the user's head or the movement or operation of the controller 210 is detected in the control unit 340 as input content including the operation of the user's position, line of sight, attitude, speech, operation, etc., and a control program stored in the storage unit 350 is executed in accordance with the user's input content to perform a process such as controlling the character 4 and generating an image. The user input detecting unit 410 may also receive input from an input device 312, such as a keyboard or a mouse. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head and the movement or operation of the controller, a character control unit 420 that executes a control program stored in the control program storage unit 460 for a character 4 stored in the character data storage unit 450 of the storage unit 350, a camera control unit 440 that controls the virtual camera 3 disposed in the virtual space 1 according to the character control, and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4.

The storage unit 350 stores in the aforementioned character data storage unit 450 information related to the character 4, such as the attribute of the character 4, as well as the image data of the character 4. The control program storage unit 460 controls the operation and expression of the character 4 in the virtual space and stores a program for controlling an object such as the camera 3. The image data storage unit 470 stores the image generated by the image producing unit 430. In this embodiment, the image stored in the image data storage unit 470 is considered to be action data for generating a moving image. The action data may include, for example, 3D data for displaying the character 4 in the virtual space 1, pause data for identifying the bone structure of the 3D data, motion data for identifying the movement of the bone structure, and the like. The action data is stored for each character 4 (or for each object if an object other than character 4 exists). The action data is accompanied by timing data so that the operation of each character 4 (and each object) can be synchronized. In addition to the action data, the image producing unit 430 may register a moving image generated (rendered) based on the action data in the image data storing unit 470. Here, the image producing unit 430 generates a moving image in which the frame rate is different between the character 4 and an object other than the character 4 (e.g., a background image). The image producing unit 430 may lower the frame rate of the character 4 than other objects, for example, 12 to 15 FPS (Frames Per Second) for the operation of the character 4, and 30 FPS (frame rate of the camera 3) for the background image. This allows for the creation of moving images of so-called limited animations. It is also possible to increase the frame rate of the character 4 over the frame rate of other objects.

### <Play Movie>

The control unit 340 also includes a movie playback unit 490 for playing back an image stored in the image data storage unit 470. The movie playback unit 490 can play back the moving image based on the action data. As described above, the action data is accompanied by timing data, and based on this, a moving image in which each character 4 (and each object) is operated in synchronization can be generated.

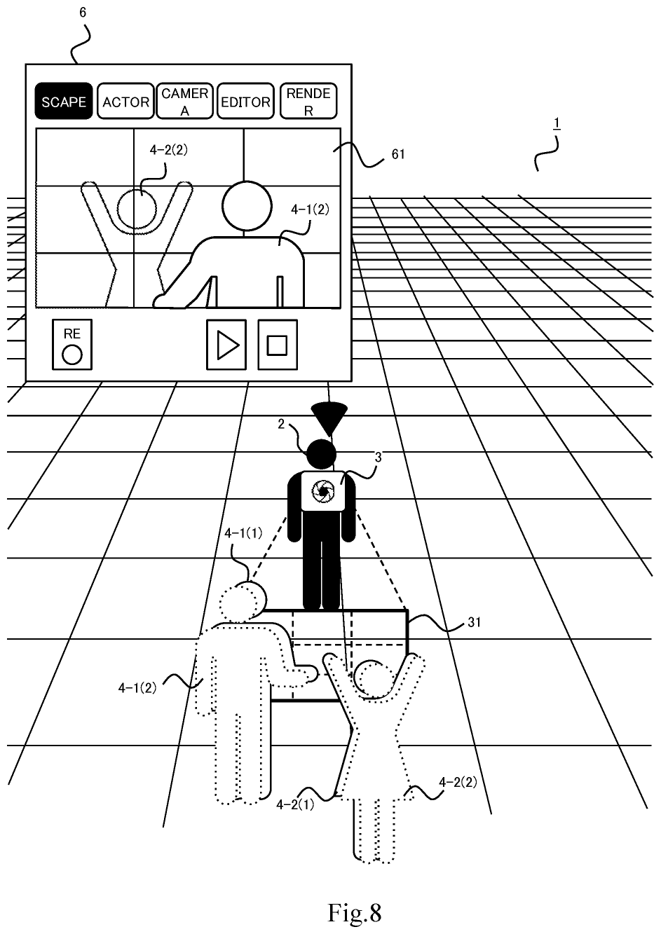

Here, the moving image played back by the movie playback unit 490, i.e., the moving image viewed by the HMD 110, shall be the same frame rate as other objects (e.g., background images). For example, if the moving image displayed by HMD 110 is 90 FPS, the playback of the character 4 is also 90 FPS. For this reason, in the present embodiment, each character 4 in the virtual space 1 is duplicated, i.e., another character 4 replicated for each character 4 is disposed. FIG. 8 is a diagram illustrating a state in which each character 4 is duplexed. In the example of FIG. 8, for the character 4-1, two characters 4-1(1) and 4-1(2) are disposed, and for the character 4-2, two characters 4-2(1) and 4-2(2) are disposed. Character 4-1(1) and character 4-1(2) are represented by action data having the same shape and the same operation. The character 4-2(1) and the character 4-2(2) are represented by action data having the same shape and the same operation. One of the two characters 4 is used for display on the display panel 120 of the HMD 110 while the other is used for display on the display unit 61 of the control panel 6 or the display device 311 and/or for storage in the image data storage unit 470. For example, in the example of FIG. 1, the characters 4-1(1) and 4-2(1) are used for display on the display panel 120 of the HMD 110, and the characters 4-1(2) and 4-2(2) are used for display on the display unit 61 of the control panel 6 and the display device 311 (and/or for storage in the image data storage unit 470).

When the movie is played, the character 4 also operates in the virtual space 1 based on the action data. When a movie is played, the movement of the character 4 can be corrected while the movie is being played by the user possessing the character 4 and manipulating the character 4. Here, when the movie playback unit 490 plays back an image, the frame rate of the character 4 is set to the frame rate for recording and is set to a rate preferred for viewing through the HMD 110, thereby facilitating work in the virtual space 1. On the other hand, when the image producing unit 430 performs the output as the final animated video to the display device 311 or the like, the frame rate of the character 4 can be represented differently from the frame rate (i.e., the frame rate of the camera 3) of other objects such as the background image. The frame rate can also be changed by a character 4. That is, the image producing unit 430 can set any frame rate less than or equal to the frame rate captured by the camera 3 for each object to generate a video. For example, the image producing unit 430 may increase the frame rate when the movement of the object is faster than a predetermined high-speed threshold value, or when the movement of the object is lower than a predetermined low-speed threshold value.

As described above, according to the animation production system 300 of the present embodiment, a user can operate the camera 3 as the camera man 2 in the virtual space 1 to take video images. Accordingly, since the camera 3 can be operated in the same way as in the real world to take photographs, it is possible to realize a natural camera work and to provide a richer representation of the animated video.

Further, according to the animation production system 300 of the present embodiment, in the dynamic image as the ultimate animation, the frame rate of the character 4 is lower than the frame rate of other objects such as the background image, thereby realizing an animation-like representation. On the other hand, for the image viewed by the HMD 110, the character 4 also has the same frame rate as other objects, thereby reducing the discomfort of the work experience in the virtual space 1.

Further, according to the animation production system 300 of the present embodiment, the frame rate can be easily changed by duplicating each character 4 and using one character 4 for operation in the virtual space 1 and the other character 4 for output as the final animated video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

In the present embodiment, the grid 31 is divided into three sections, vertically and horizontally, but a dividing line 32 that is divided in any number can be displayed.

In the present embodiment, the user possessed by the camera man 2 or the character 4 performs an operation to adjust the position of the grid 31. However, the position of the grid 31 may be adjusted in a state where the virtual space 1 is overviewed (the user is not possessed by the camera man 2 or the character 4). In this case, the user can grasp and move the grid 31.

In this embodiment, although the display device 311 is intended to display the image in the real space, the display device 311 can be performed in an extended real space (AR; Augmented Reality) or a complex real space (MR; Mixed Reality) in addition to the real space or in place of the real space. In this case, the user viewing the display 311 can view the screen 7 in the AR/MR space using a device such as an AR/MR glass instead of the display 311 or a user different from the user viewing the display 311.

In the present embodiment, it has been described that the frame rate of the character 4 is different from the frame rate of an object other than the character 4 (such as a background image, not shown), but the frame rate may be variable for each object including the character 4. In this case, a frame rate may be set for each object type, or a unique frame rate may be set for each object. Each object can be duplicated, the same shape, the same operation, and the same position, while one object can be used for operation in virtual space 1, and the other object can be used for output to animated video.

In addition, different frame rates may be set depending on the timing on the time axis. For example, a different frame rate can be set for any object depending on the period, such that the interval between time t1 and time t2 is 15 fps and 60 fps from time t3 to time t4. The frame rate may be set manually by the user or automatically by the system. When the system automatically sets the frame rate, for example, when a background sound (BGM) is added to a video, the frame rate can be changed according to the rhythm of the BGM. The frame rate can also be varied depending on the distance between the camera 3 and the character 4 (or other object).

### EXPLANATION OF SYMBOLS

1 virtual space
2 cameraman
3 cameras
4 characters
6 control panel
7 Screens
31 Grid
32 split line
61 display
62 playback button
71 display
72 playback button
110 HMD
120 display panel
130 housing
140 sensor
150 light source
210 controller
220 left hand controller
230 right hand controller
235 grip
240 trigger button
250 Infrared LED
260 sensor
270 joystick
280 menu button
300 Animation Production System
310 Image Generator
311 display
312 input device
320 I/O portion
330 communication section
340 controller
350 storage
410 User Input Detector
420 character control unit
430 Image Generator
440 Camera Control
450 character data storage section
460 Program Storage
470 Image Data Storage
490 Movie Playback Unit

1. An animation production method wherein
a computer executes:
a step of placing a character in a virtual space;
a step of placing a virtual camera for shooting the character;
a step of controlling the action of the character; and
a step of generating a movie in which the character is virtually captured by the camera,
wherein a first frame rate in relation to the action in the step of controlling the action of the character and a second frame rate in relation to the action of the character output to the movie in the step of generating the movie are different.

2. The animation production method according to claim 1, wherein
in the step of placing the character, two duplexed characters are placed,
in the step of controlling, displaying the action of one of the two characters at the first frame rate,
in the step of generating the movie, the action of the other of the two characters is output at the second frame rate.

3. An animation production method according to claim 1, wherein
the second frame rate is lower than the first frame rate.
